(19) United States
(12) Patent Application Publication
(10) Pub. No.: US 2026/0286808 A1
(43) Pub. Date: Sep. 24, 2026

(54) A PIPING SYSTEM TO RECOVER FLUID FROM A WELL OR TO INJECT FLUID IN A WELL AND RELATED METHOD

(71) Applicant: TotalEnergies OneTech, COURBEVOIE (FR)

(72) Inventor: Neil WALKER, PAU CEDEX (FR)

(73) Assignee: TotalEnergies OneTech, COURBEVOIE (FR)

(21) Appl. No.: 19/474,651

(22) PCT Filed: Apr. 11, 2024
(86) PCT No.: PCT/EP2024/059901

§ 371 Date: Oct. 10, 2025

(30) Foreign Application Priority Data
Apr. 13, 2023 (EP) 23305559.9

(51) Int. Cl. E21B 34/02; F16K 3/02; F16K 31/50; F16K 31/53

(52) U.S. Cl. CPC E21B 34/025; F16K 3/0254; F16K 31/508; F16K 31/53; E21B 2200/03

(57) ABSTRACT

The system comprises a fluid flow pipe; a valve, comprising a valve stem configured to be mobile along a first horizontal axis in the flow pipe between an open position in which fluid is able to flow in the flow pipe and a closed position in which fluid is unable to flow in the flow pipe; a valve jack, having an actuating rod connected to the valve, the rod being configured to translate along the first horizontal axis to move the valve stem between the open position and the closed position, and a port mechanically connected to the rod, the port being configured to be rotated by an actuator. The port is rotatable about a second vertical axis orthogonal to the first horizontal axis.

### CROSS REFERENCE TO RELATED APPLICATIONS

The present application is a U.S. National Phase Application under 35 U.S.C. § 371 of International Patent Application No. PCT/EP2024/059901 filed Apr. 11, 2024, which claims priority to European Application No. EP 23305559.9 filed Apr. 13, 2023. The entire contents of which are hereby incorporated by reference.

### FIELD

The present invention concerns a piping system to recover fluid from a well or to inject fluid in a well, comprising:
at least a fluid flow pipe;
at least a valve, comprising a valve stem configured to be mobile along a first horizontal axis in the flow pipe between at least one open position in which fluid is able to flow in the flow pipe and a closed position in which fluid is unable to flow in the flow pipe; and for the or each valve:
a valve jack, having an actuating rod connected to the valve, the rod being configured to translate along the first horizontal axis to move the valve stem between the at least one open position and the closed position, and a port mechanically connected to the rod, the port being configured to be rotated by an actuator to translate the rod.

### BACKGROUND

In particular, the piping system is placed underwater, on or near the bottom of a body of water. For example, the piping system is arranged above or near a wellhead through which a fluid is produced from the well or a fluid is injected in the well. In a variant, the piping system is located on a topsides facility.

An example of fluid produced from the well comprises hydrocarbons, such as oil and gas. A fluid injected in the well is for example a gas, in particular a carbon-containing gas such as carbon dioxide, to capture the carbon-containing gas in the well and reduce the concentration of greenhouse gases in the atmosphere. In a variant, the fluid injected is a gas to be stored in the well for a later usage, such as hydrogen or more generally a liquid, such as water.

In particular, the piping system is a Christmas tree connected to a wellhead, a subsea distribution unit (or “SDU”), a high integrity pipeline protection system (or “HIPPS”), a blow-out preventer (or “BOP”), an emergency disconnection package (or “EDP”), a lower riser package (or “LRP”) or an inline tree (or “ILT”).

Such a piping system generally comprises several fluid flow pipes into which fluid produced from the well or fluid to be injected in the well can flow.

At least part of the fluid flow pipes are equipped with valves. The valves are operable to control the fluid flow through the pipe. The valves are for example, gate valves, ball valves or choke valves.

Each valve is controlled by an actuator which operates a valve jack. The valve jack has a rod translating generally horizontally to actuate the valve.

In traditional systems, the operation of the actuators is hydraulic. However, in new piping systems, in particular in recent Christmas trees, the actuators are electrically operated.

A known electrical Christmas tree generally has an outer framework having side vertical faces through which electrical actuators are connected in a horizontal direction to the valve jacks.

Each valve jack comprises a horizontal port to which a rotatable electrical actuator head can connect. The valve jack uses a roller or screw thread drive mechanism to convert the actuator-generated rotation of the port about a horizontal axis in a horizontal translation of the rod.

Such a design allows a full electrical operation of the valves in the piping system. It is nevertheless not entirely satisfactory.

In particular, the assembly of horizontal actuators at the end of the valve stem substantially increases the overall Christmas tree footprint in a horizontal plane, due to the horizontal protrusion of the electrical actuator. This is detrimental, as in most cases, the environment at the top of a well contains a lot of equipment, with little space available for new equipment.

Additionally, access to the side face of the Christmas tree framework to put in place and/or replace a horizontal actuator with a remotely operated vehicle (“ROV”) is often difficult, requires using bulky guidance systems, and thus consumes costly operation time.

More broadly, electrical Christmas trees have many ROV recoverable components, all needing docking/guidance/locking systems which add to the bulkiness and complexity of the Christmas tree.

The electrical actuators and other electrical components require many electrical harnesses all around the Christmas tree and numerous wet-mate connectors to electrically power them. These connectors are known to be weakness points and may cause failures.

### SUMMARY

One aim of the invention is thus to obtain a very compact piping system with operable valves, in particular configured to be electrically operated, which is yet very reliable and easily maintained.

To this aim, the subject matter of the invention is a piping system of the above-mentioned type, characterized in that the port is rotatable about a second vertical axis (orthogonal to the first horizontal axis.

The piping system according to the invention may comprise one or more of the following feature(s), taken solely, or according to any technical feasible combinations:
the valve jack comprises an intermediate gear converting the rotation of the port about the second vertical axis in a translation of the rod along the first horizontal axis;
the valve jack is a screw jack, the rod having an outer thread, the port having a worm shaft with an external thread, the intermediate gear being in mesh externally with the external thread and in mesh internally with the outer thread;
the port comprises a free upper end equipped with a bucket to receive a rotatable actuator head;
the valve jack has a housing defining a horizontal access opening opposed to a first end of the rod acting on the at least one valve, a second end of the rod protruding through the horizontal access opening to allow a direct actuation of the rod by translation of a horizontal actuator;
it comprises a plurality of flow pipes and a plurality of valves, each valve having a valve stem configured to be mobile along a horizontal axis in at least one of the flow pipe between at least one open position in which fluid is able to flow in the at least one of the flow pipe and a closed position in which fluid is unable to flow in the at least one of flow pipe; and for each valve:
a valve jack, having a rod connected to the valve, the rod being configured to translate along the horizontal axis to move the valve stem between the at least one open position and the closed position, and a port mechanically connected to the rod,
the ports of the valves being configured to be rotated around parallel vertical rotation axes;
it comprises an outer framework, the or each flow pipe and the or each valve being at least partially contained in the outer framework, the outer framework defining an upper access opening emerging upwardly to allow an access to the or each port of the or each valve jack;
it comprises a movable panel movably mounted on the outer framework between a covering position covering the upper access opening and an access position at least partially apart from the upper access opening, preferentially totally apart from the outer framework;
the movable panel comprises a lower surface facing the or each port in the covering position, the piping system comprising for the or each valve, an actuator mounted on the lower surface, the actuator being engaged with the port in the covering position and the actuator being disengaged from the port in the access position;
the actuator is an electrical actuator, the piping system comprising at least a wet mate electrical connector borne by the movable panel to receive an electrical connection to an outside power source;
it comprises at least a battery to power the electrical actuator, the battery being borne by the lower surface of the movable panel and being electrically connected to the actuator and to the at least one wet mate connector, advantageously via dry mate connections;
it comprises a downhole interface unit and/or an electrical subsea control module borne by the lower surface of the movable panel or/and it comprises power and/or communication components intended to plug to fixed items received in the outer framework, the power and/or communication components being borne by the lower surface;
the outer framework comprises at least a vertical face, the vertical face delimiting a side through passage facing the horizontal access opening, a horizontal free volume extending between the side through passage and the second end of the rod protruding through the horizontal access opening;
the piping system is a Christmas tree connected to a wellhead, a subsea distribution unit, a high integrity pipeline protection system, an emergency disconnection package, a lower riser package or an in-line tree.

The invention also concerns a method to recover fluid from a well or to inject fluid in a well, comprising:
flowing a fluid from the well or to the well in at least a fluid flow pipe of a piping system as defined above,
rotating the port of the valve jack by an actuator about the second rotation axis to translate the rod of the valve along the first horizontal axis,
moving the valve stem along the first horizontal axis in the flow pipe between the at least one open position in which fluid is able to flow in the flow pipe and the closed position in which fluid is unable to flow in the flow pipe.

The method according to the invention may comprise one or more of the following feature(s), taken solely or according to any technical feasible combination:
the fluid comprises hydrocarbon fluid produced from the well or is a fluid injected in the well, in particular a gas such as a carbon containing fluid to be captured in the well, typically carbon dioxide, or such as hydrogen or in particular a liquid to be injected in the well such as water;
the piping system comprises an outer framework, the or each flow pipe and the or each valve being at least partially contained in the outer framework, the outer framework defining an upper access opening emerging upwardly to allow an access to the or each port of the or each valve jack, the method comprising moving a movable panel mounted on the outer framework between a covering position covering the upper access opening and an access position at least partially apart from the upper access opening, preferentially totally apart from the outer framework, the movable panel comprising a lower surface facing the or each port in the covering position, the piping system comprising for the or each valve, an actuator mounted on the lower surface, the actuator being engaged with the port in the covering position and the actuator being disengaged from the port in the access position, the lower surface of the movable panel also advantageously carrying a at least a battery to power the actuator, a downhole interface unit, an electrical subsea control module and/or power and/or communication components intended to plug to fixed items received in the outer framework in the covering position.

The invention will be better understood, based on the following description, given solely as an example and with reference to the appended drawings, in which:

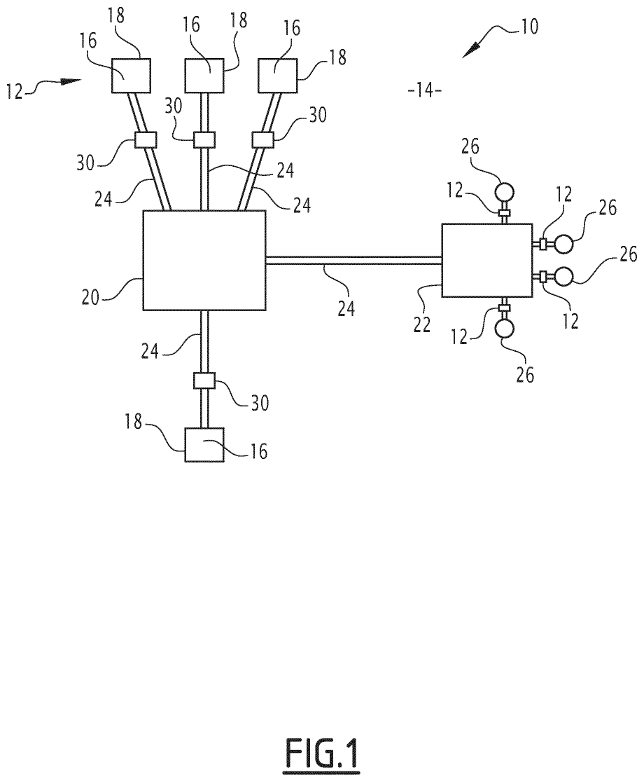

FIG. 1 is a schematic upper view of an example of an underwater fluid exploitation installation, the installation comprising at least a piping system according to the invention;

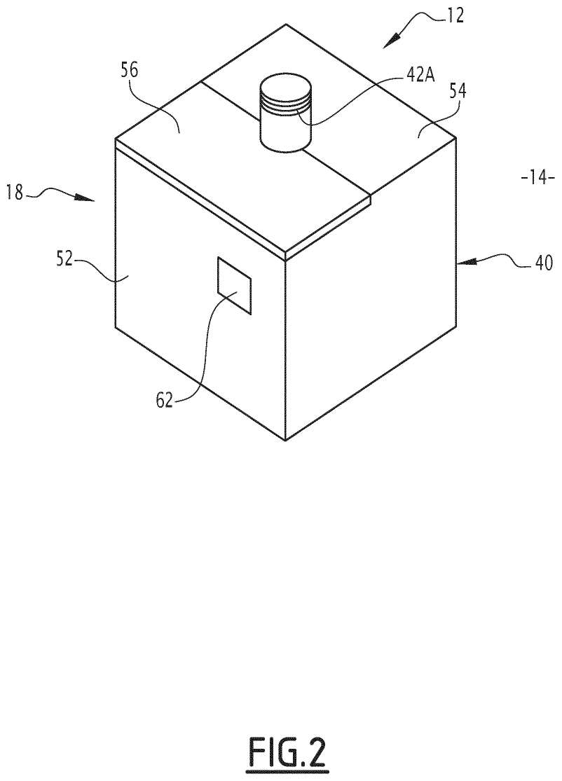

FIG. 2 is an upper perspective view of the piping system according to the invention, having a roof panel in a covering position;

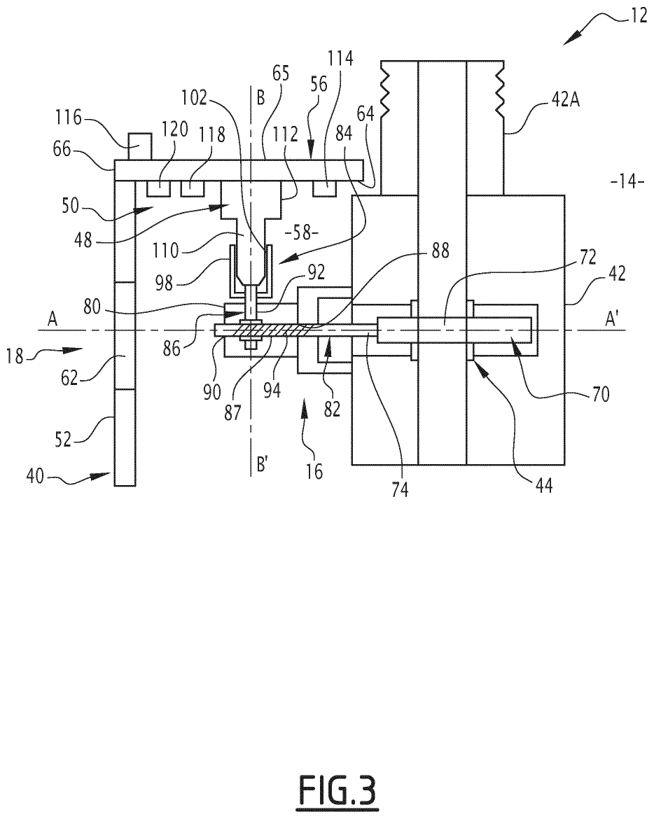

FIG. 3 is a schematic vertical cross section of a detail of the piping system of FIG. 2, having a valve in an open position;

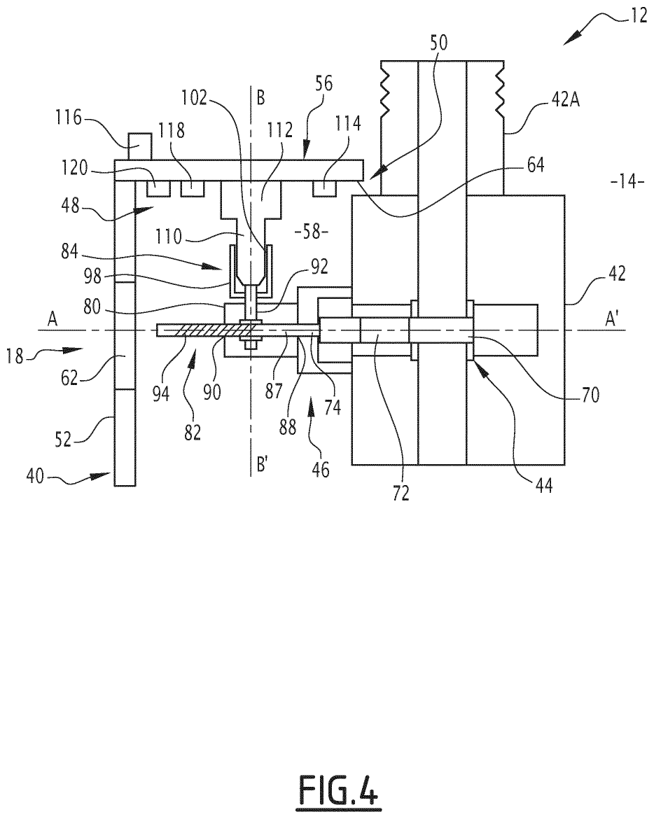

FIG. 4 is a view similar to FIG. 3, with the valve in a closed position;

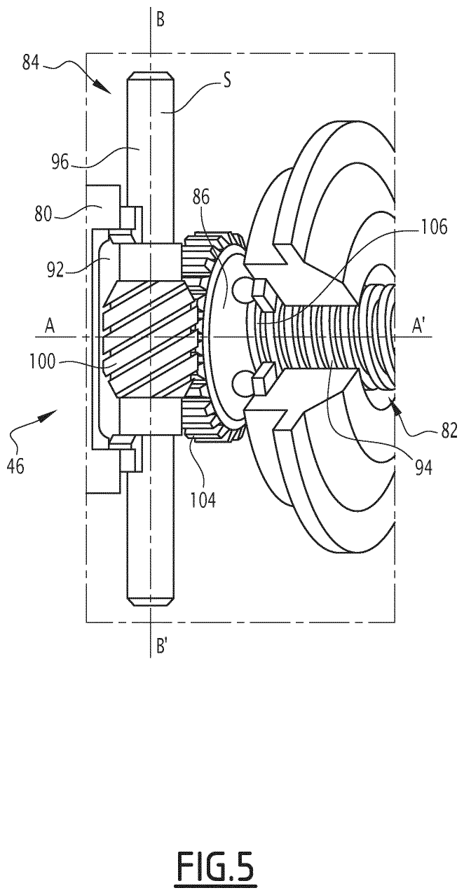

FIG. 5 is a perspective view of a worm gear mechanism of a valve jack connected to the valve;

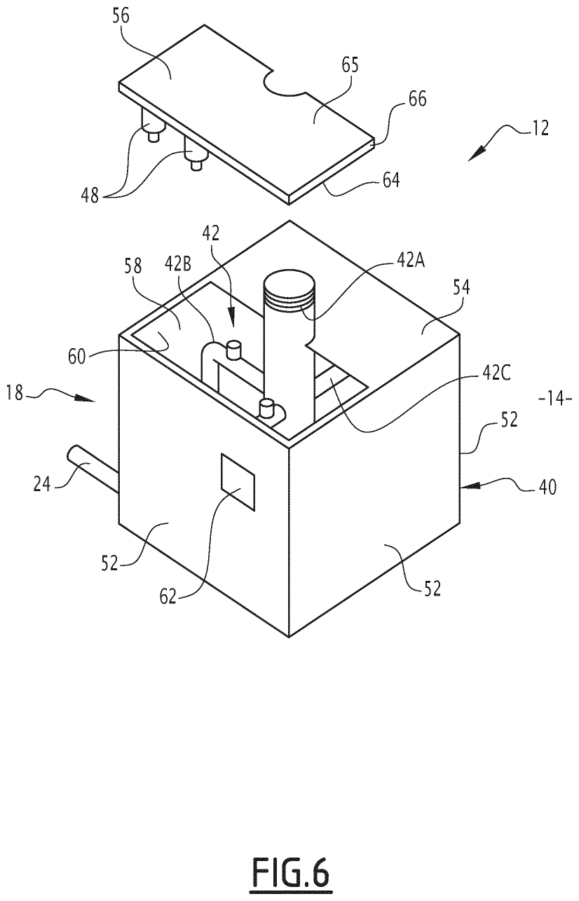

FIG. 6 is a view similar to FIG. 2, with the roof panel in an access position.

In the following, the term “horizontal” has to be generally understood as a direction defining an angle of 90° plus or minus 10°, preferably plus or minus 5° with the direction of gravity.

### DETAILED DESCRIPTION

The term “vertical” has to be generally understood as a direction defining an angle of 0° plus or minus 10°, preferably plus or minus 5° with the gravity.

The term “A is orthogonal to B” generally means that A is a direction defining an angle of 90° plus or minus 10°, preferably plus or minus 5°, with direction B.

A first installation 10 comprising a piping system 12 according to the invention is shown schematically in FIG. 1. The installation 10 is a fluid exploitation installation, in particular a fluid production installation or a fluid injection installation.

When fluid is produced from the underground in the installation 10, the fluid advantageously comprises hydrocarbons, in particular oil and gas. When fluid is injected in the underground, the fluid is for example a carbon-containing gas such as carbon dioxide. In a variant, the fluid injected is a gas to be stored in the well for a later usage, such as hydrogen or more generally a liquid such as water.

The installation 10 shown in FIG. 1 is a fluid production installation located in a body of water 14, in particular at the bottom of the body of water 14.

The installation 10 comprises at least a well 16 bored in the ground, a wellhead (not shown) closing each well 16 and a Christmas tree 18 to regulate fluid flow through the wellhead.

The installation 10 further comprises a subsea distribution unit comprising at least a manifold 20 collecting the fluid produced from one or more wells 16 and a termination 22 to transfer the fluid produced in the wells 16 and collected in the manifold 20 towards a surface installation (not shown).

The installation 10 further comprises several flow pipes 24 connecting respectively each Christmas tree 18 to the manifold 20 and connecting the manifold 20 to the termination 22.

The installation 10 may comprise high integrity pipeline protection systems 30 and/or an emergency disconnection package (not shown).

The installation 10 also comprises other flow pipes 26 connecting the termination 22 to the surface, the latter flow pipes being generally referred to as “risers”, the termination 22 forming a lower riser package.

An example of piping system 12 according to the invention is shown in FIGS. 2 to 6. The piping system 12 is here a Christmas tree 18 mounted on top of a wellhead.

In variant, the piping system 12 is a subsea distribution unit/manifold, a high integrity pipeline protection system, a blow-out preventer, an emergency disconnection package, a lower riser package and/or an inline tree.

Turning back to the example of FIGS. 2 to 6, the piping system 12 comprises an outer framework 40. The piping system 12 also includes, advantageously contained in the outer framework 40, fluid flow pipes 42, and at least a valve 44 to control fluid flow within at least one of the fluid flow pipes 42. The outer framework 40 may also contain fixed tree items such as wet mate electrical flying leads from downhole electrical functions, from a multiphase flow meter, from a choke actuator and/or from power and communication connections.

As shown in FIGS. 4 and 5, the piping system 12 further comprises, associated to each valve 44, a valve jack 46 to operate the valve 44 via an actuator 48.

In the example of FIGS. 2 to 6, the piping system 12 is an electrically operated piping system 12 which comprises an electrical unit 50. The electrical unit 50 is preferably a single unit movable in one piece, as will be described below.

As shown in FIGS. 2 and 6, the outer framework 40 comprises several side vertical faces 52 in particular at least three, preferably four side vertical faces 52.

In this example, the outer framework 40 further comprises at least a fixed roof panel 54, and at least a removable roof panel 56, which advantageously carries the electrical unit 50.

The side vertical faces 52 delimit between them an inner volume 58 at least partially receiving the fluid flow pipes 42 and receiving each valve 44. The side vertical faces 52 and the fixed roof panel 54 when present, define an upper access opening 60 to the inner volume 58, which is covered by the removable roof panel 56. At least a side vertical face 52 defines a side through passage 62 facing a valve jack 46, to horizontally access the valve jack 46.

The removable roof panel 56 has a lower surface 64 facing the inner volume 58, and an opposed outer surface 65, and/or a side surface 66.

The fluid flow pipes 42 comprise vertical fluid flow pipes 42A, horizontal fluid flow pipes 42B, and/or inclined or curved fluid flow pipes 42C.

In the example of a Christmas tree 18 shown in FIG. 6, at least a vertical fluid flow pipe 42A has a lower end connected to the wellhead, and has an upper end protruding partially above the outer framework 40 through the roof panels 54, 56 to allow the connection of a blow-out preventer (BOP).

At least a lateral fluid flow pipe 42B extends laterally to connect to a flow line 24 outside of the Christmas tree 18.

In the Christmas tree 18, at least a flow pipe 42 is equipped with at least a valve 44, potentially with several valves 44. In this example, several fluid flow pipes 42A, 42B are each equipped with a valve 44.

In the example of FIGS. 3 and 4, the valve 44 is a gate valve. In a variant, the valve 44 is a ball valve or a choke valve actuated with a horizontally moving valve stem.

When the valve 44 is a gate valve, it comprises a solid shutter 70, configured to close the flow of fluid within a canal 68 defined in the fluid flow pipe 42, and a through hole 72 through which fluid flow can flow when the through hole 72 is placed in the fluid canal 68. The valve 44 further comprises a valve stem 74 connecting the shutter 70 to the valve jack 46.

The valve stem 74 is configured to move with regards to the fluid flow pipe 42 along a first horizontal axis A-A′, between an open position shown in FIG. 3, and a closed position shown in FIG. 4.

In the open position, fluid is able to flow in the flow pipe 42. The through hole 72 is positioned within the canal 68 and allows fluid to pass through. In the closed position, fluid is unable to flow in the fluid flow pipe 42. The solid shutter 70 closes the canal 68, and prevents fluid from passing through the shutter 70.

The stem 74 extends horizontally, in a prolongation of the shutter 70.

The valve jack 44 comprises an intermediate gear mechanism configured to convert a rotation movement about a vertical axis into a translation movement along a horizontal axis.

The valve jack 44 is a screw jack, in particular a worm drive jack. In a variant, the valve jack 44 has a lead/ball/roller screw drive.

In the example of FIGS. 3 to 5, the valve jack 44 comprises a housing 80, a horizontal actuating rod 82, connected to or integral with the valve stem 74, to allow a connection with the valve 44, the rod 82 being configured to translate along the first horizontal axis A-A′ to move the valve stem 74 between the open position and the closed position.

The valve jack 46 further comprises a vertical port 84 configured to be engaged by an actuator 48 and to be rotated by the actuator 48 about a second vertical rotation axis B-B′, orthogonal to the first horizontal axis A-A′.

The valve jack 46 further comprises a worm gear 86, to convert the rotation of the port 84 about the second vertical axis B-B′ in a translation of the rod 82 along the first horizontal axis A-A′.

In reference to FIGS. 3 and 4, the housing 80 internally defines a horizontal longitudinal passage 87 extending along the first horizontal axis A-A′. The horizontal passage 87 emerges at a first longitudinal, opening 88 towards the valve 44, and at an opposed second longitudinal opening 90, facing the side through passage 62.

The horizontal passage 87 receives the actuating rod 82. A first end of the actuating rod 82 connected to the valve 44 protrudes through the first opening 90 and a second end of the actuating rod 82 protrudes out of the housing 80 through the second opening 90.

The rod 82 has an outer thread 84 at least in the portion received within the housing 80.

Thanks to the provision of the side through passage 62, the second end of the actuating rod 82 is configured to be engaged by a horizontal actuator (not shown) inserted in the side through passage 62 to directly manoeuver the actuating rod 82 without having to directly actuate the vertical port 84.

The housing 80 further defines a second vertical passage 92 extending along the second vertical axis B-B′ and intersecting the first horizontal passage 87.

In the example of FIGS. 4 and 5, the port 84 comprises a rotatable worm shaft 96 mounted in the second vertical passage 92. It advantageously comprises a bucket 98 for engagement with the actuator 48.

The rotatable shaft 96 is rotatable around the second vertical axis B-B′. It comprises an external helical thread 100 at least in its central part located at the crossing between the first horizontal passage 87 and the second vertical passage 92.

The bucket 98, when present, is connected to an upper end of the rotatable shaft 96. It comprises an inner receiving space 102 for receiving at least a head 110 of the actuator 48. The actuator head 110 is configured to engage the bucket 98 to jointly rotate the bucket 98 and the worm shaft 96.

For each valve 44, the port 84 of the valve jack 46 protrudes upwardly in a free space located above the fluid flow pipe 42 and extending up to the upper access opening 60.

Thus, each port 84 of a valve jack 46 is vertically accessible from above the outer framework 40, to be operated by an external actuator (for example carried by a ROV) when the removable roof panel 56 is removed, or by an actuator 48 of the electrical unit 50 when the removable roof panel 56 is present.

Thus, the valve jack 46 does not need to horizontally protrude out of the outer framework 40. The valve jack 46 is easily accessible from above through the upper access opening 60. The footprint of the piping system 12 is therefore minimized, thanks to this particular configuration of the valve jack 46.

The worm gear 86 is arranged at the crossing between the horizontal passage 87 and the vertical passage 92. It comprises an outer gearing 104, in mesh with the external helical thread 100 of the rotatable shaft 96, and an inner thread 106 defined around an inner longitudinal cavity receiving the rod 82, the outer thread 94 of the rod 82 being in mesh with the inner thread 106 of the worm gear 86.

Thus, a rotation of the rotatable shaft 96 about the second vertical axis B-B′ produce a corresponding rotation of the worm gear 86 around the first horizontal axis A-A′ and thus a translation of the actuating rod 82 along the same axis A-A′.

The electrical unit 50 is mounted on the roof panel 56, with all components of the electrical unit 50 being carried by and jointly movable with the roof panel 56.

In the present case, the electrical unit 50 comprises at least an actuator 48 having a rotatable head 110 and a motor 112, and at least a battery 114 to power the actuator 48. It further comprises at least a wet-mate connector 116 to connect the battery 114 to an external electrical source, for example through a cable or an umbilical and/or to a surface controller to transmit information to the electrical unit 50.

In some instances, the electrical unit 50 further comprises at least a downhole interface unit 118, an electrical subsea control module 120.

The electrical unit 50 may also comprise electrical cabling, as well as power and/or communication components configured to connect through wet mate connectors to the electrical flying leads from fixed tree items such as downhole electrical functions, multiphase flow meter, choke actuator and/or power and communication connections, when present.

Each actuator 48 protrudes vertically from the lower surface 64 of the removable roof panel 56. Each actuator 48 is located at a predefined position on the lower surface 64 of the roof panel 56 such that the actuator head 110 directly engages the port 84 of a corresponding valve jack 46 when the removable roof panel 56 is placed in the covering position.

It is thus very easy to put in place, to maintain, or/and to replace each actuator 48 by simply removing the roof panel 56 carrying the electrical unit 50 in one piece.

The same roof panel 56 or a replacement roof panel 56 can then be put back in place at the same position on the outer framework 40.

The battery 114 is also borne on the lower surface 64 of the roof panel 56. It is electrically connected to the motor 112 and to the wet-mate connector 116 for recharging the battery 114.

The downhole interface unit 118 and the electrical subsea control module 120, when present, are also carried by the lower surface 64 of the removable panel 56.

The downhole interface unit 118 is configured to communicate and control the actuation of equipment in the well below the Christmas tree 18.

The electrical subsea module 120 is configured to communicate and control equipment on the Christmas tree 18.

Just as each actuator 48, each of the battery 114, the wet-mate connector 116, the downhole interface unit 118, the electrical subsea control module 120, and when present, the power and/or communication components intended to connect to the fixed tree items can be easily maintained and/or replaced by vertically moving the removable roof panel 56 above the outer framework 40.

Moreover, the downhole interface unit 118 and the electrical subsea control module 120 and the power and/or communication components are all connected to a limited number of wet-mate connectors 116 by hard connections and dry connectors. The risk of leaking or malfunction is greatly diminished.

The number of wet-mate connectors 116 in the electrical unit 50 borne by the removable roof panel 56 is preferentially very low, for example smaller than 5, for example comprised between 2 and 4.

The use of the piping system 12 according to the invention during the production and/or during the injection of a fluid in a well 16 will now be described.

When a fluid produced from the well 16 or a fluid to be injected in the well 16 circulates within the fluid flow pipes 42, a valve 44 operation may be needed.

In that case, the battery 114 is activated to power the motor 112 of the actuator 48. The rotatable head 110 of the actuator 48 rotates about the second vertical axis B-B′ and rotates the port 84, preferentially by engagement with the bucket 98.

The rotatable shaft 96 consequently rotates about the second vertical axis B-B′, and drives in rotation the worm gear 86 about the first horizontal axis A-A′. The worm gear 86 translates the actuating rod 82 along the first horizontal axis A-A′. This horizontally moves the valve stem 74 and the shutter 70 between the open position and the closed position or conversely.

If a component of the electrical unit 50 has a malfunction, or needs to maintained and/or replaced, the electrical unit 50 is moved as a single piece by vertically lifting the removable roof panel 56.

Each actuator head 110 disengages from its corresponding port 84 and the upper access opening 60 is freed.

The same removable panel 56 or a replacement removable panel 56 is then lowered vertically towards the upper access opening 60. It is then guided towards the covering position.

A permanent guide or a temporary guide is advantageously provided to land the removable panel 56 without damaging the other components.

Each actuator 48 is aligned vertically with a respective port 84. The rotatable head 110 of the actuator 48 thus easily engages the port 84.

Similarly, when the removable panel 56 occupies its covering position, the electrical flying leads from fixed tree items such as downhole electrical functions, multiphase flow meter, choke actuator and/or power and communication connections directly plug into the electrical unit 50 through wet mate connectors.

Each wet-mate connector 116 is then connected to an electrical source or to a source of information.

The electrical components of the electrical unit 50 can then operate to manage the piping system 12. All electrical connections and information transfer connections are thus easily managed.

In case the valve jack 46 cannot be operated with the actuator 48, it is still possible to insert a linear actuator (not shown) in the side through passage 62. The linear actuator directly engages the actuating rod 82 to manoeuver the valve 44, without having to use the port 84.

Thanks to the configuration of the piping system 12 according to the invention, the piping system 12 remains extremely compact and has a small horizontal footprint, even it is fully electrically operated.

The piping system operation 12 is very reliable, since the number of wet-mate connectors 116 is limited by integration of all electrical components within the electrical unit 50. The interfacing of the electrical unit 50 with different components of the piping system 12 to which they must connect is thus very simple. As mentioned above, just a vertical movement of the removable roof panel 56 allows all the components to be removed or set up, which significantly reduces maintenance and replacement costs.

Consequently, multiple wet-mates, subsea harnesses, guidance funnels and ROV interfaces can be removed and the cost of the piping system 12 is also reduced. Electronic components and modules can be changed entirely if there is a component failure, for example of an actuator 48, which minimizes the downtime of the installation 10.

In the preceding description, the piping system 12 is a Christmas tree 18. In variant, the piping system 12 according to the invention is a subsea distribution unit, a high integrity pipeline protection system, an emergency disconnection package, a lower riser package, an inline tree, all located underwater.

In another variant, the piping system 12 according to the invention is mounted on a topsides facility, in particular having electrically operated valve systems.

In another variant, the removable panel 56 comprises multiple plates movable in one piece or one after the other.

1. A piping system to recover fluid from a well or to inject fluid in a well, comprising:
at least a fluid flow pipe;
at least a valve, comprising a valve stem configured to be mobile along a first horizontal axis in the flow pipe between at least one open position in which fluid is able to flow in the flow pipe and a closed position in which fluid is unable to flow in the flow pipe; and for the or each valve:
a valve jack, having an actuating rod connected to the valve, the rod being configured to translate along the first horizontal axis to move the valve stem between the at least one open position and the closed position, and a port mechanically connected to the rod, the port being configured to be rotated by an actuator to translate the rod,
wherein the port is rotatable about a second vertical axis orthogonal to the first horizontal axis.

2. The piping system according to claim 1, wherein the valve jack comprises an intermediate gear converting the rotation of the port about the second vertical axis in a translation of the rod along the first horizontal axis.

3. The piping system according to claim 2, wherein the valve jack is a screw jack, the rod having an outer thread, the port having a worm shaft with an external thread, the intermediate gear being in mesh externally with the external thread and in mesh internally with the outer thread.

4. The piping system according to claim 1, wherein the port comprises a free upper end equipped with a bucket to receive a rotatable actuator head.

5. The piping system according to claim 1, wherein the valve jack has a housing defining a horizontal access opening opposed to a first end of the rod acting on the at least one valve, a second end of the rod protruding through the horizontal access opening to allow a direct actuation of the rod by translation of a horizontal actuator.

6. The piping system according to claim 1, comprising a plurality of flow pipes and a plurality of valves, each valve having a valve stem configured to be mobile along a horizontal axis in at least one of the flow pipe between at least one open position in which fluid is able to flow in the at least one of the flow pipe and a closed position in which fluid is unable to flow in the at least one of flow pipe; and for each valve:
a valve jack, having a rod connected to the valve, the rod being configured to translate along the horizontal axis to move the valve stem between the at least one open position and the closed position, and a port mechanically connected to the rod,
the ports of the valves being configured to be rotated around parallel vertical rotation axes.

7. The piping system according to claim 1, comprising an outer framework, the or each flow pipe and the or each valve being at least partially contained in the outer framework, the outer framework defining an upper access opening emerging upwardly to allow an access to the or each port of the or each valve jack.

8. The piping system according to claim 7, comprising a movable panel movably mounted on the outer framework between a covering position covering the upper access opening and an access position at least partially apart from the upper access opening.

9. The piping system according to claim 8, wherein the movable panel comprises a lower surface facing the or each port in the covering position, the piping system comprising for the or each valve, an actuator mounted on the lower surface, the actuator being engaged with the port in the covering position and the actuator being disengaged from the port in the access position.

10. The piping system according to claim 9, wherein the actuator is an electrical actuator, the piping system comprising at least a wet mate electrical connector borne by the movable panel to receive an electrical connection to an outside power source.

11. The piping system according to claim 10, comprising at least a battery to power the electrical actuator, the battery being borne by the lower surface of the movable panel and being electrically connected to the actuator and to the at least one wet mate connector.

12. The piping system according to claim 10, comprising a downhole interface unit and/or an electrical subsea control module borne by the lower surface of the movable panel, or/and comprising power and/or communication components intended to plug to fixed items received in the outer framework, the power and/or communication components being borne by the lower surface.

13. The piping system according to claim 7, wherein the valve jack has a housing defining a horizontal access opening opposed to a first end of the rod acting on the at least one valve, a second end of the rod protruding through the horizontal access opening to allow a direct actuation of the rod by translation of a horizontal actuator, and wherein the outer framework comprises at least a vertical face, the vertical face delimiting a side through passage facing the horizontal access opening, a horizontal free volume extending between the side through passage and the second end of the rod protruding through the horizontal access opening.

14. The piping system according to claim 1, wherein the piping system is a Christmas tree connected to a wellhead, a subsea distribution unit, a high integrity pipeline protection system, an emergency disconnection package, a lower riser package or an in line tree.

15. A method to recover fluid from a well or to inject fluid in a well, comprising:
flowing a fluid from the well or to the well in at least a fluid flow pipe of a piping system according to claim 1,
rotating the port of the valve jack by an actuator about the second rotation axis to translate the rod of the valve along the first horizontal axis,
moving the valve stem, along the first horizontal axis in the flow pipe between the at least one open position in which fluid is able to flow in the flow pipe and the closed position in which fluid is unable to flow in the flow pipe.

16. The method according to claim 15, wherein the fluid comprises hydrocarbon fluid produced from the well or is a fluid injected in the well, in particular a gas such as a carbon containing fluid to be captured in the well, typically carbon dioxide, or such as hydrogen or in particular a liquid to be injected in the well such as water.

17. The method according to claim 15, wherein the piping system comprises an outer framework, the or each flow pipe and the or each valve being at least partially contained in the outer framework, the outer framework defining an upper access opening emerging upwardly to allow an access to the or each port of the or each valve jack, the method comprising moving a movable panel mounted on the outer framework between a covering position covering the upper access opening and an access position at least partially apart from the upper access opening, the movable panel comprising a lower surface facing the or each port in the covering position, the piping system comprising for the or each valve, an actuator mounted on the lower surface, the actuator being engaged with the port in the covering position and the actuator being disengaged from the port in the access position.

18. The method according to claim 17, wherein in the access position, the movable panel is totally apart from the outer framework.

19. The method according to claim 18, wherein the lower surface of the movable panel also carries at least a battery to power the actuator, a downhole interface unit, an electrical subsea control module and/or power and/or communication components intended to plug to fixed items received in the outer framework in the covering position.

20. The piping system according to claim 11, wherein the battery is electrically connected to the actuator and to the at least one wet mate connector.

21. The piping system according to claim 8, wherein in the access position, the movable panel is totally apart from the outer framework.
